(19) United States
(12) Patent Application Publication
(10) Pub. No.: US 2016/0000039 A1
(43) Pub. Date: Jan. 7, 2016

(54) Takedown pet nail grinder

(71) Applicant: Kuo-Wei Chou, New Taipei City (TW)

(72) Inventor: Kuo-Wei Chou, New Taipei City (TW)

(21) Appl. No.: 14/854,038

(22) Filed: Sep. 15, 2015

(51) Int. Cl. A01K 13/00; A01K 15/02

(52) U.S. Cl. CPC A01K 13/00; A01K 15/024

(57) ABSTRACT

A takedown pet nail grinder includes a rectangular, inclined platform including four downward extending tabs at four corners respectively, and front, rear, and two side stops wherein each of the front and rear stops have an inward bending part; two triangular side panels each including first projections formed on a first edge, second projections formed on a second edge, and third projections formed on a third edge; a rectangular rear panel including protrusions formed on both sides respectively; and a hard board disposed on a top surface of the platform. The tabs are inserted into the side panels for being positioned. The first, second, and third projections are inserted into the platform for being positioned. The protrusions are inserted into the side panels for being positioned. Front and rear ends of the hard board are restrained by the bending parts respectively.

### BACKGROUND OF THE INVENTION

1. Field of the Invention

The invention relates to nail grinders and more particularly to a takedown nail grinder for pet.

2. Description of Related Art

A pet's nails (e.g., a dog's or a cat's nails) grow quickly. A dog or a cat may grind its nails against a hard object in order to wear them down.

A conventional claw clipper for a pet comprising a body having an elongated handle; a head positioned at a front portion of the body and having a claw insertion hole located at one side of the head; a cutting mechanism adjacent to the hole and having a fixed cutter element inside the head and a movable cutter element inside the head which cooperates with the fixed cutter element; a lever connected to the movable cutter element and pivotally connected to the body for rotation relative to the body, the lever diagonally extending away from a lower side of the body; and an adjustable stop mounted on the body at the head and movable to adjust the length a claw may be inserted into the hole.

While the claw clipper for pet enjoys its success in the market, continuing improvements in the exploitation of pet nail grinder are constantly sought.

### SUMMARY OF THE INVENTION

It is therefore one object of the invention to provide a pet nail grinder comprising a rectangular, inclined platform including four downward extending tabs at four corners respectively, and front, rear, and two side stops wherein each of the front and rear stops have an inward bending part; two triangular side panels each including a plurality of first projections formed on a first edge, a plurality of second projections formed on a second edge, and a plurality of third projections formed on a third edge; a rectangular rear panel including a plurality of protrusions formed on both sides respectively; and a hard board disposed on a top surface of the platform; wherein the tabs are inserted into the side panels for being positioned, the first, second, and third projections are inserted into the platform for being positioned, the protrusions are inserted into the side panels for being positioned, and front and rear ends of the hard board are restrained by the bending parts respectively.

The above and other objects, features and advantages of the invention will become apparent from the following detailed description taken with the accompanying drawings.

### BRIEF DESCRIPTION OF THE DRAWINGS

FIG. 1 is a perspective view of a platform of a pet nail grinder according to the invention;

FIG. 2 is another perspective view of the platform;

FIG. 3 is a perspective view of a side panel;

FIG. 4 is another perspective view of the side panel;

FIG. 4A is a detailed view of the area in circle A of FIG. 4;

FIG. 5 is a perspective view of a rear panel;

FIG. 6 is an exploded view showing the platform, the two side panels, and the rear panel to be assembled;

FIG. 7 is a perspective view of the assembled pet nail grinder;

FIG. 8 is another perspective view of the assembled pet nail grinder;

FIG. 9 is a perspective view showing a hard board to be mounted on the pet nail grinder; and

FIG. 10 is a perspective view of the assembled hard board and the pet nail grinder.

### DETAILED DESCRIPTION OF THE INVENTION

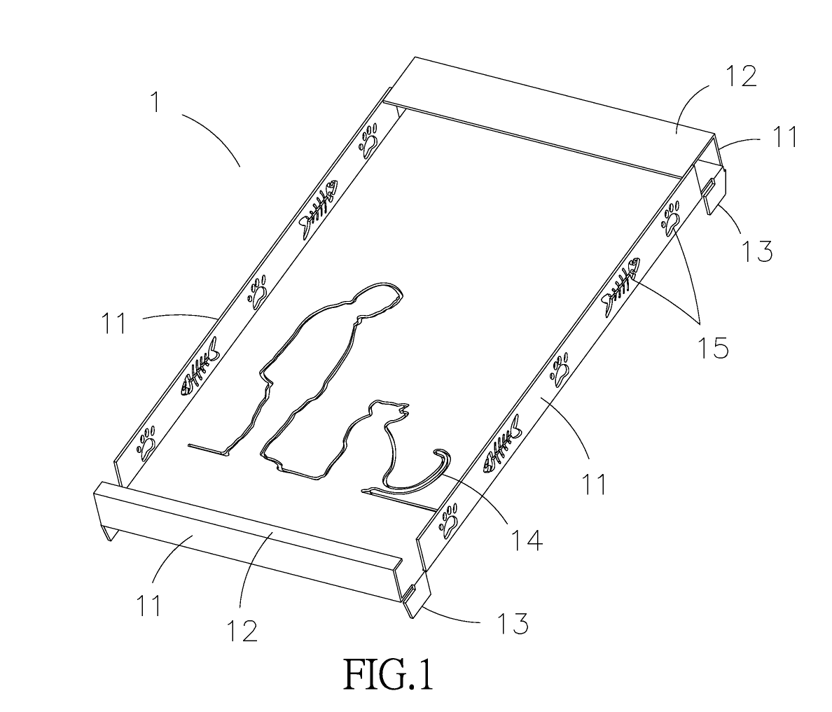

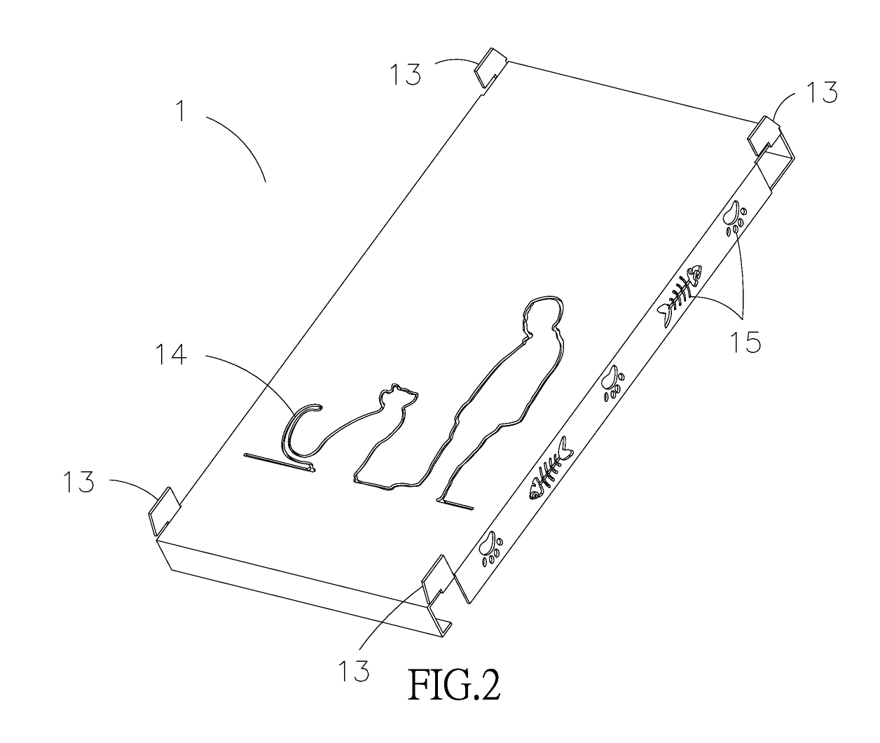

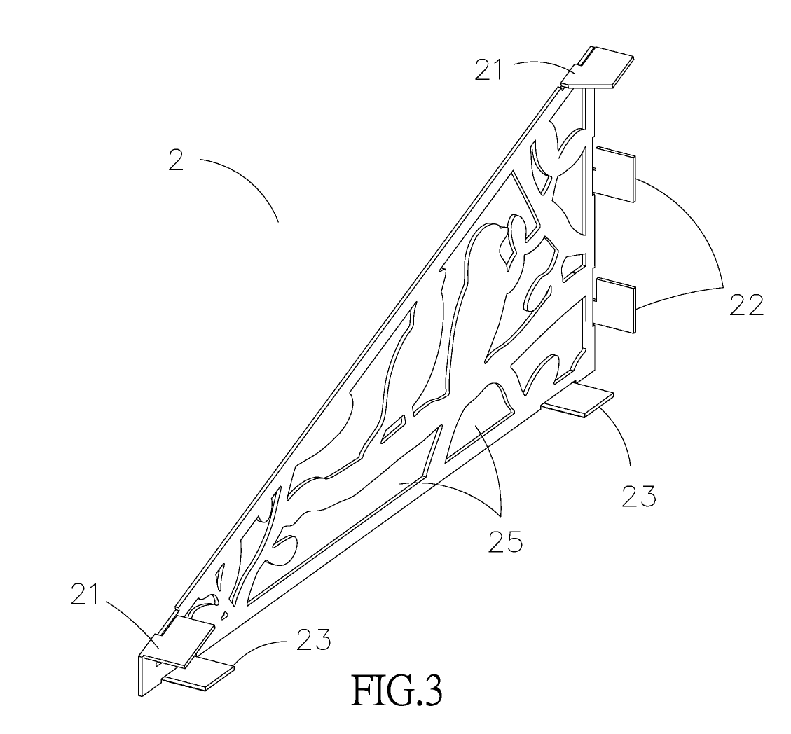

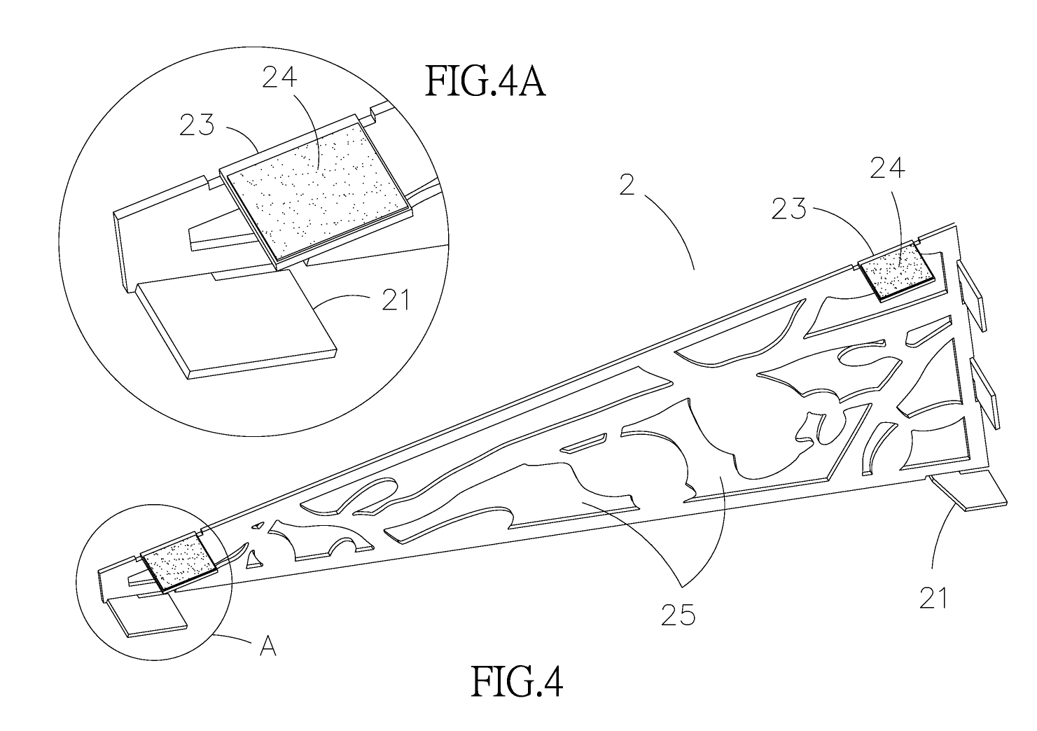

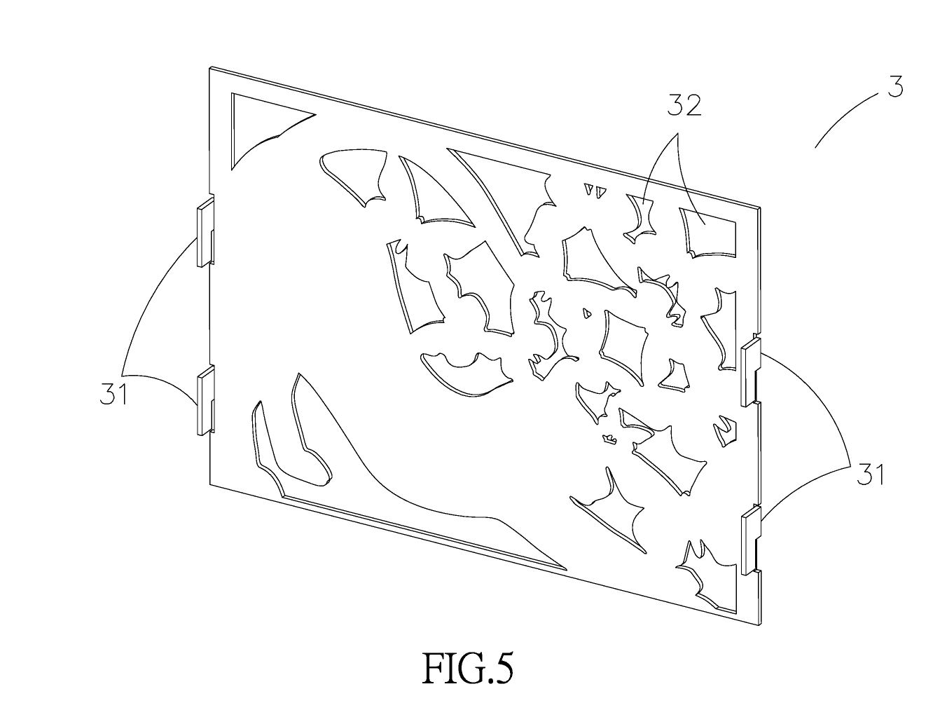

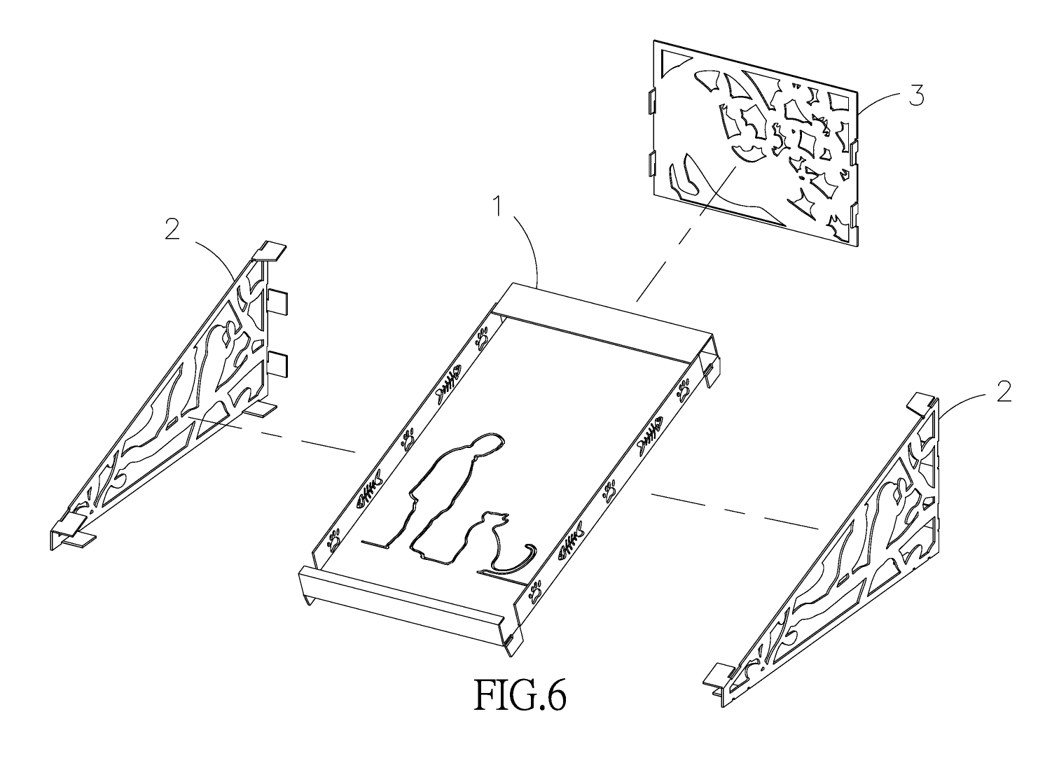

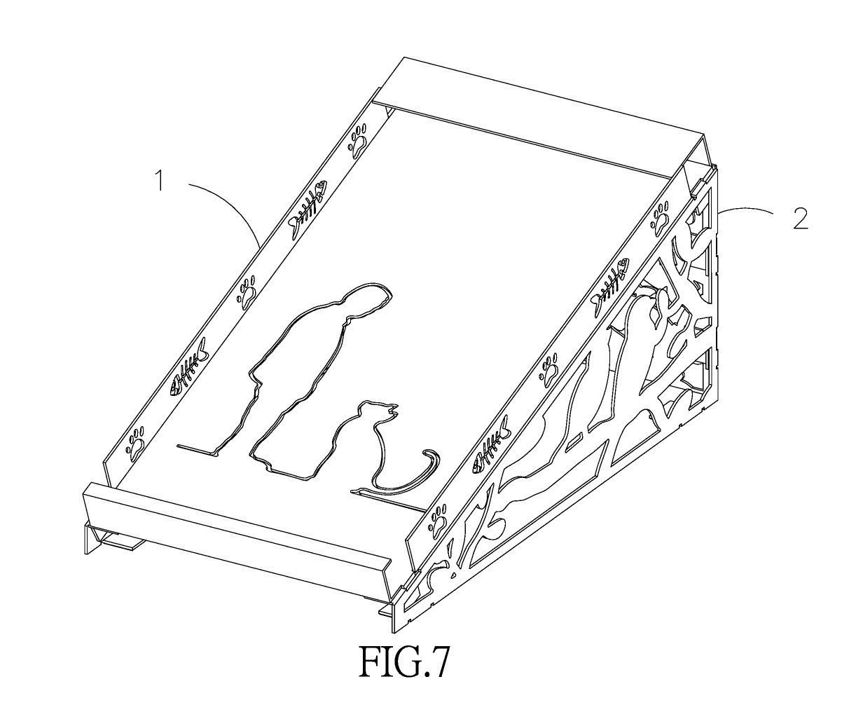

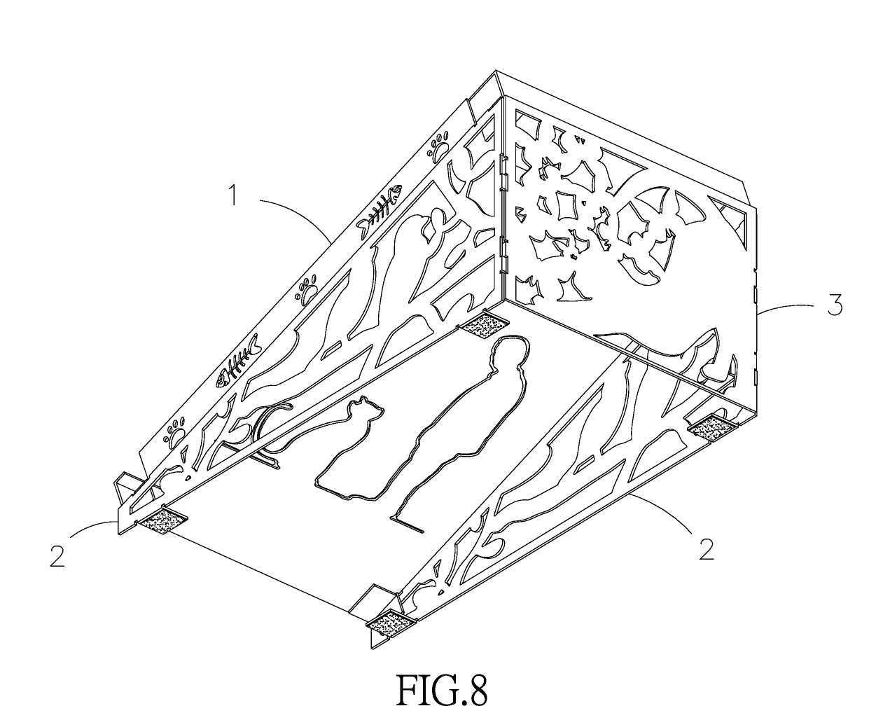

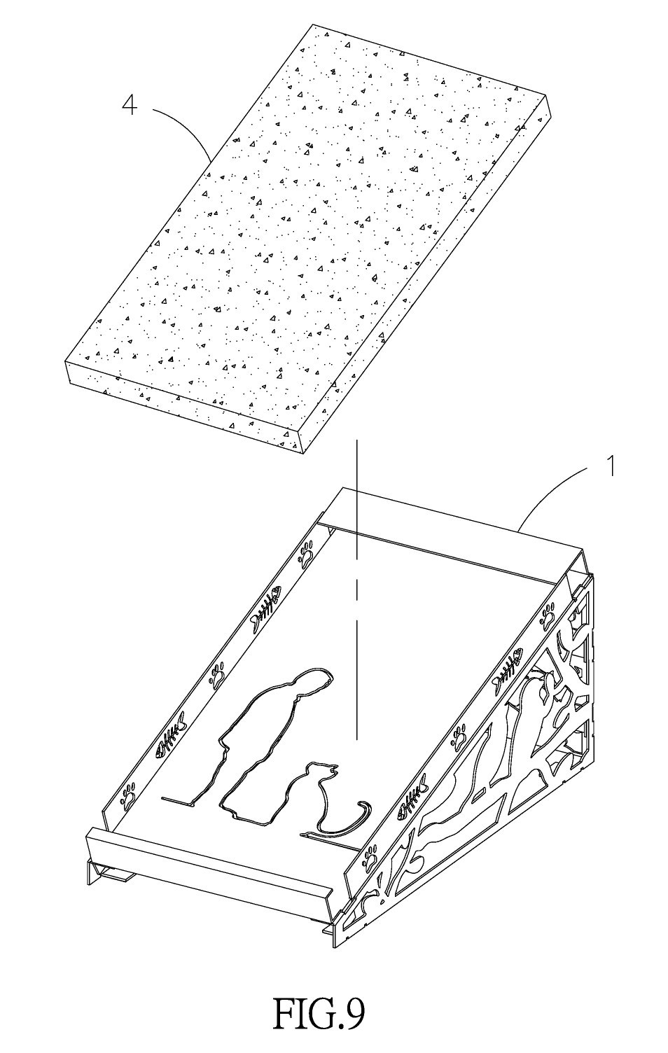

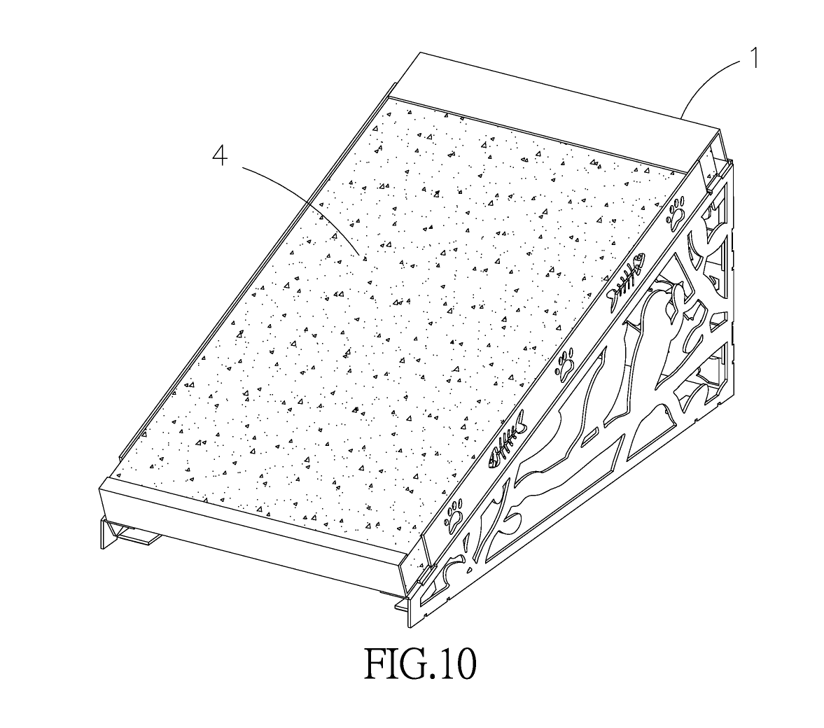

Referring to FIGS. 1 to 10, a pet nail grinder in accordance with the invention comprises the following components as discussed in detail below.

A rectangular, inclined platform 1 includes front, rear, and two side stops 11, 12 in which each of the front and rear stops 11 have an inward bending part 12, four downward extending tabs 13 at four corners respectively, a shaped groove 14 formed on a top surface, and a plurality of shaped openings 15 formed on both side stops 11 respectively.

Two triangular side panels 2 each include first, second, and third projections 21, 22, 23 formed on three edges respectively, two slip-resistant pads 24 each disposed on a bottom surface of the third projection 23, and a plurality of openings 25.

A rectangular rear panel 3 includes a plurality of protrusions 31 formed on both sides respectively, and a plurality of openings 32. A hard board 4 is disposed on the top surface of the platform 1.

In assembly, the tabs 13 are inserted into the side panels 2 for being positioned. The first, second, and third projections 21, 22, 23 are inserted into the platform 1 for being positioned. The protrusions 31 are inserted into the side panels 2 for being positioned. Front and rear ends of the hard board 4 are restrained by the bending parts 12 respectively. The slip-resistant pads 24 are placed on the ground for preventing the grinder from moving easily. A pet (e.g., cat or dog) may grind its nails against the hard board 4 to wear them down.

While the invention has been described in terms of preferred embodiments, those skilled in the art will recognize that the invention can be practiced with modifications within the spirit and scope of the appended claims.

What is claimed is:

1. A pet nail grinder comprising:
a rectangular, inclined platform including four downward extending tabs at four corners respectively, and front, rear, and two side stops wherein each of the front and rear stops have an inward bending part;
two triangular side panels each including a plurality of first projections formed on a first edge, a plurality of second projections formed on a second edge, and a plurality of third projections formed on a third edge;
a rectangular rear panel including a plurality of protrusions formed on both sides respectively; and
a hard board disposed on a top surface of the platform;
wherein the tabs are inserted into the side panels for being positioned; the first, second, and third projections are inserted into the platform for being positioned; the protrusions are inserted into the side panels for being positioned; and front and rear ends of the hard board are restrained by the bending parts respectively.
